(19) United States
(12) Patent Application Publication
(10) Pub. No.: US 2026/0316534 A1
(43) Pub. Date: Oct. 15, 2026

(54) Support System for Tarpaulin Coverings for Trailer Beds and an Assembly Kit for Such A Support System

(71) Applicant: Elcargo Fabrication Inc., Saint-Hyacinthe (CA)

(72) Inventors: Keven BOUTIN, Drummondville (CA); Kendrick MARTIN, Laprairie (CA)

(73) Assignee: Elcargo Fabrication Inc., Saint-Hyacinthe, QC (CA)

(21) Appl. No.: 19/692,237

(22) Filed: May 29, 2026

Related U.S. Application Data
(63) Continuation of application No. PCT/CA2024/051680, filed on Dec. 17, 2024.
(60) Provisional application No. 63/613,338, filed on Dec. 21, 2023.

(51) Int. Cl. B60J 7/08; B62D 33/04

(52) U.S. Cl. CPC B60J 7/085; B62D 33/04

(57) ABSTRACT

A support system for supporting tarpaulin coverings for trailer beds is provided. The system includes a plurality of planar beams configured to be attached end to end to span an entire length of the trailer without an intermediate support post. A kit of parts for assembling the support system for supporting tarpaulin coverings for trailer beds is also provided.

### CROSS-REFERENCE TO RELATED APPLICATION(S)

This application is a Continuation of PCT Patent Application No. PCT/CA 2024/051680 filed on Dec. 17, 2024; which claims priority to U.S. Provisional Patent Application No. 63/613,338 filed on Dec. 21, 2023, the contents of which are incorporated herein by reference in their entirety.

### TECHNICAL FIELD

The following generally relates to support systems for supporting tarpaulin coverings for trailer beds.

### BACKGROUND

Trailers are used in many hauling applications and come in numerous configurations, including closed box configurations, open top configurations, open side configurations, and flatbed configurations, to name a few. Each of these configurations can have advantages or disadvantages depending on what is being hauled. For example, closed box configurations may be required to maintain temperature control or to more securely protect the contents but can only be accessed via doors at the back end of the trailer. On the other hand, open top or open side configurations can provide increased access to the bed when the contents being hauled do not require the same temperature control or security considerations.

Open side trailers are typically covered over one or both sides by a tarpaulin (also referred to here as a “tarp” for brevity) or other covering. The tarpaulin is often extended out and over the opening to cover or “close” the open side and rolled back about a rod to retract the tarpaulin to expose the open side of the trailer. The tarpaulin used in an open side trailer is typically supported above the trailer bed and requires a support structure to stabilize the tarpaulin extension/retraction system during operation in addition to maintaining its position above the bed.

### SUMMARY

In one aspect, there is provided a support system for supporting tarpaulin coverings for trailer beds, the system comprising: a plurality of planar beams configured to be attached end to end to span an entire length of the trailer without an intermediate support post.

In certain example embodiments, the support system further includes a plurality of support elements configured to span the length of the trailer and support the plurality of planar beams.

In certain example embodiments, the support system further includes a pair of brace components positioned between ends of the beams and/or support elements and upstanding walls of the trailer positioned at each end.

In certain example embodiments, the plurality of support elements comprises a plurality of trusses coupled together and to the beams.

In certain example embodiments, the trusses span between the planar beams and a plurality of slender beams positioned beneath the plurality of planar beams.

In certain example embodiments, the brace components comprise an arcuate face and a pair of corner faces, an upper corner face positioned against the plurality of support elements and a substantially orthogonal end face positioned against a respective upstanding wall.

In certain example embodiments, the support system further includes at least one support member positioned along the support system, each support member being biased into an upstanding position and being urged into a substantially planar position when the tarpaulin covering unrolls thereover.

In another aspect, there is provided a kit of parts for assembling a support system for supporting tarpaulin coverings for trailer beds, the kit of parts comprising the support system in any of the embodiments defined above.

### BRIEF DESCRIPTION OF THE DRAWINGS

Embodiments will now be described with reference to the appended drawings wherein:

FIG. 1 is a perspective view of a trailer bed having a support structure for a pair of tarpaulin coverings.

FIG. 2 is an enlarged partial perspective view of the trailer of FIG. 1.

FIG. 3 is an enlarged partial elevation view of a corner brace for the support structure of FIG. 1.

FIGS. 4a, 4b, and 4c are an enlarged partial perspective views of the corner brace shown in FIG. 3.

FIG. 5 is a partial perspective view of an alternative brace for a support structure for a pair of tarpaulin coverings.

FIG. 6 is an end elevation view of the trailer of FIG. 1.

FIG. 7 is a side elevation view of the trailer of FIG. 1.

FIG. 8a is a side elevation view of the trailer showing an example load.

FIG. 8b is a side elevation view of the trailer showing another example load.

FIG. 9 is a partial perspective view of the trailer showing another example load.

FIG. 10 is a cross-sectional end view of the trailer along the line A-A in FIGS. 7, 8a and 8b.

FIG. 11 is an enlarged view of a portion of the end view of FIG. 10.

FIG. 12 is an enlarged partial perspective view of an end portion of a trailer of the type shown in FIG. 1 with a pair of tarpaulin coverings.

FIG. 13. is an end view of the trailer shown in FIG. 12.

FIG. 14 is an enlarged partial perspective view of a pair of braces against which a retracted tarpaulin covering sits when in a retracted or open configuration.

FIG. 15 is an exploded view of a kit of parts for the support structure shown in FIG. 1.

FIGS. 16A, 16B, 16C, and 16D are exploded views illustrating packaging options for the kit of parts shown in FIG. 15.

FIGS. 17A and 17B illustrate a kit of parts in a shipping configuration using the packaging options shown in FIGS. 16A-16D.

### DETAILED DESCRIPTION

Support structures used to position a trailer covering system such as a system using one or more tarpaulins, typically requires upstanding posts or large cross members within the storage volume of the trailer, which reduces the storage capacity and flexibility of objects that can be stored. For example, such upstanding posts may limit the ability to haul objects that span the width of the bed of the trailer or extend along substantially the entire length of the interior of the trailer. These posts may also be configured such that they are removable on the outer edge of the trailer. This requires manual intervention and still limits the loading space or inhibits the ease of loading. To reduce obstructions within the trailer's storage volume, a support system is described herein, which can support one or more covering systems without requiring interior posts, thus increasing the storage volume and reducing obstructions.

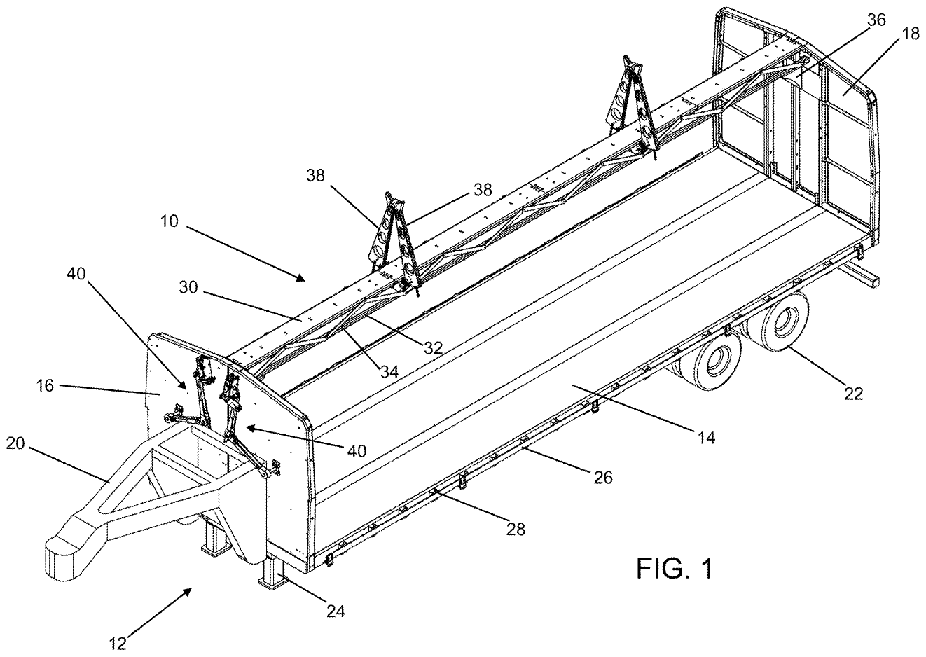

Referring now to the figures, FIG. 1 illustrates a support system 10 adapted to be utilized with a trailer 12. The trailer 12 in this example is a gooseneck type trailer, however it will be appreciated that the support system 10 can be adapted to various other types of trailers, such as flatbed trailers and the like. The trailer 12 in this example includes a bed 14 for supporting goods being hauled. The bed 14 also supports a frontend upstanding bulkhead wall 16 at one end and a backend upstanding bulkhead wall 18 at the opposite end. The support system 10 spans the length of the trailer bed 14 between the bulkhead walls 16, 18. The trailer 12 is supported by a set of axles 22 near the backend and a pair of support legs 24 towards the frontend of the trailer 12, which permit the trailer 12 to be substantially level when disconnected from a truck or other towing device. In this example, the trailer 12 includes a gooseneck 20, which is a structure adapted to couple the trailer 12 to a particular coupling mechanism on the truck being used (not shown). Moreover, the trailer 12 in this example includes a rub rail 26 coupled along the edge of the bed 14. On the rub rail are a series or set of downwardly facing hooks 28, which are used to secure the tarpaulin system against the bed 14 in a closed configuration as described in more detail below. As indicated, the type of trailer 12 shown is for illustrative purposes only.

The support system 10 in the example shown in FIG. 1 includes a series or set of planar (e.g., substantially flat) upper beams 30 that when placed end-to-end span the length of the bed 14 between the bulkhead walls 16, 18. The upper beams 30 are supported atop a pair of supports made up of a series of interconnected trusses 34 (see also FIG. 11 described below). The supports made up of the trusses 34 are connected between the upper beams 30 and a slender lower beam 32 as described in greater detail below. It can be appreciated that the upper beams 30, lower beams 32 and trusses 34, while providing particular flexibility in assembly, storage and shipping, the same principles described herein may be achieved using one or more “I-beams” (or I-beam segments). The support system 10 may therefore constructed from a set of components that enables assembly and disassembly to/from a trailer 12 to adapt that trailer 12 to support a tarpaulin-type covering system for providing open sides and substantially open topped configurations.

The upper beams 30, trusses 34 and lower beams 32 when connected can be coupled at each end to the respective bulkhead walls 16, 18 as illustrated in FIG. 1. At each end, the connection points can be further supported by a corner brace 36, which in this example has an arcuate substantially solid configuration to increase strength while minimizing the amount of incursion into the interior space of the trailer 12 that would otherwise occur with longer support braces.

The generally inverted U-shape of the assembled support system 10 provides structural support to a tarpaulin system and inhibits torsional forces that would otherwise twist a less substantial structure spanning the length of the bed 14. Moreover, the support system 10 as shown can avoid the need for any central posts or other vertical supports that would create obstacles within the interior of the trailer 12.

The support system 10 may include or otherwise provide additional support for a set of rotating arms 38. The arms 38 operate to lower into a substantially horizontal position when a tarpaulin and rod pass thereover while returning to a substantially vertical position as shown when the tarpaulin is retracted. It can be appreciated that the arms 38 are shown in FIG. 1 for illustrative purposes to enable the support system 10 to adapt to a particular type of tarpaulin system but may be omitted or replaced with other intermediate spanning structures in other configurations. In such other configurations, the intermediate spanning structures may be coupled to the upper beams 30 or other components of the support system 10 as needed to be in a desired position to interact with the tarpaulin system. The present configuration provides additional access to the bed when compared to other configurations. For example, “shower curtain” style tarps that fold towards the front, back or middle of the bed would still cover a significant portion due to the accordioning of the material and this would provide an obstruction that is not created in the present design.

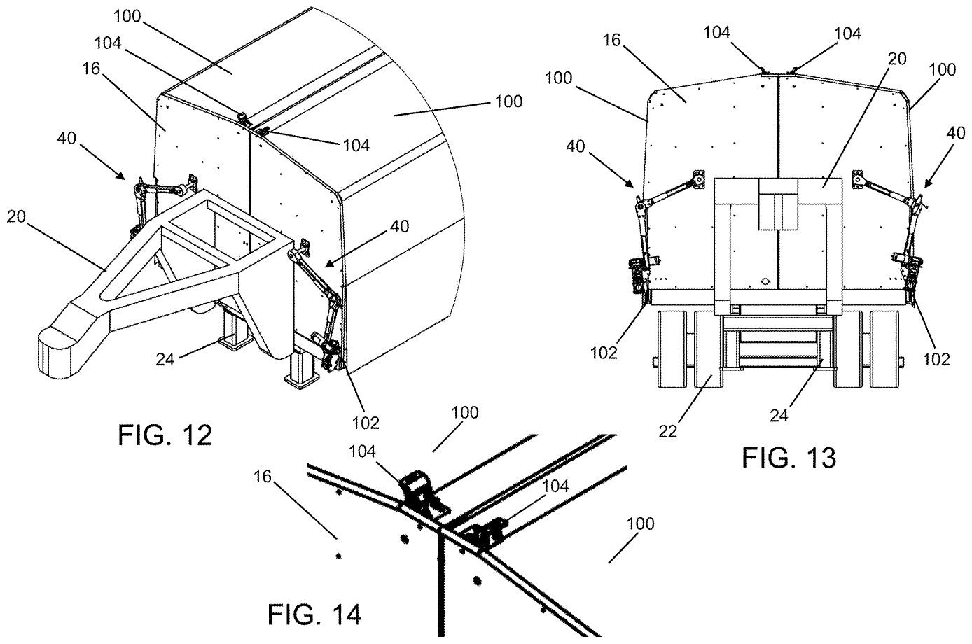

The tarpaulin system being used (e.g., see FIG. 12 described below) may be manually, automatically, or semi-automatically operated by an actuator or actuation system. In this example, the tarpaulin system may be operated by a pair of articulated actuation arms 40, one for each tarpaulin system. That is, the support system 10 in this example is centrally positioned to permit a tarpaulin system to be supported on either side such that the trailer bed 14 and its contents can be accessed from either side, thus facilitating loading, unloading, cross-docking, etc. It can be appreciated that the support system 10 may also be positioned towards one side such that it is coupled at respective upper corners of the bulkhead walls 16, 18 to provide a “one-sided” configuration. That is, the support system 10 can be adapted to be used with one or multiple tarpaulin systems to cover different portions of the trailer bed 14.

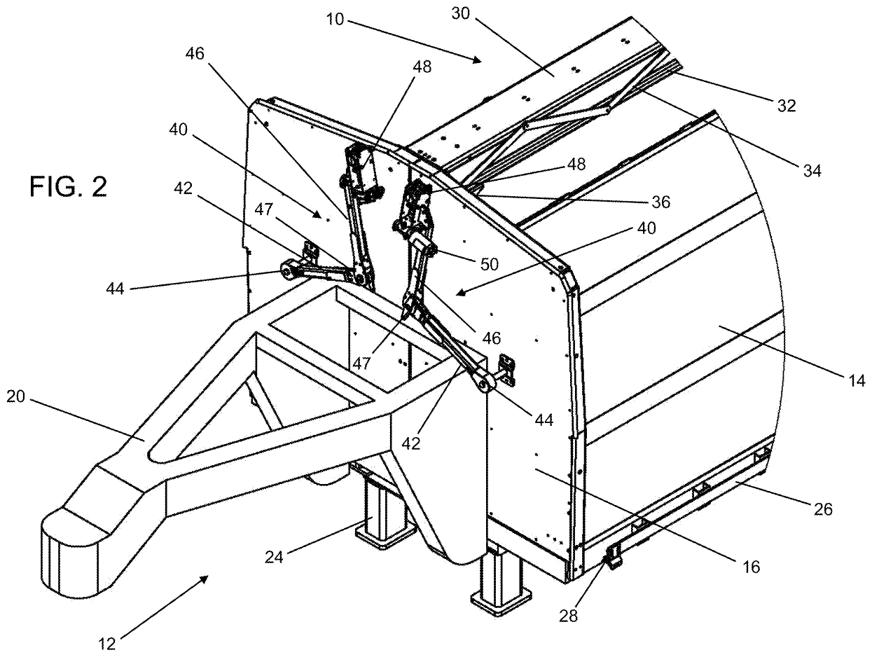

Further details concerning the actuation arms 40 can be seen in FIG. 2. Each actuation arm 40 includes a first arm 42 that is rotatably connected to the front bulkhead wall 16 at a first connection point 44, and a second arm 46 that is rotatably connected to the first arm 42 at a second connection point 47 to create an articulated actuation arm 40. The second arm 46 is connected at its distal end to an actuation device 48, which in this example provides a rotary transmission to permit rotating about an axis in two directions to permit rolling and unrolling operations. The actuation device 48 may include a motor 50 or other actuation mechanism to transfer power to the rotating rod of the tarpaulin system via the rotary transmission. It can be appreciated that the actuation arms 40 are only one example mechanism that can be used to operate a tarpaulin system. For example, manually rotatable devices operated by rods or spindles may be used. Similarly, while not shown, track devices and other guidance systems may be incorporated into the actuation and drive mechanisms to guide a tarpaulin over an opening in the trailer 12. That is, the support system 10 shown can be used with any tarpaulin system that is to be coupled thereto and supported thereby. The corner brace 36 at the front bulkhead wall 16 can also be seen in FIG. 2.

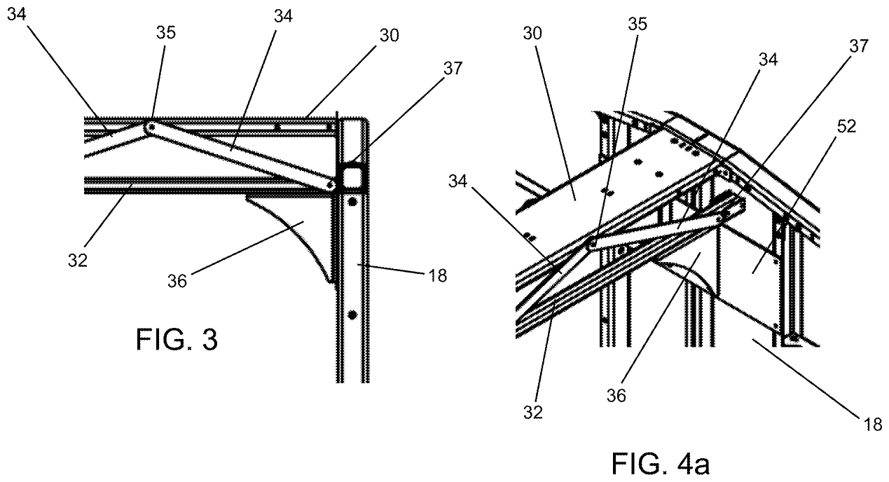

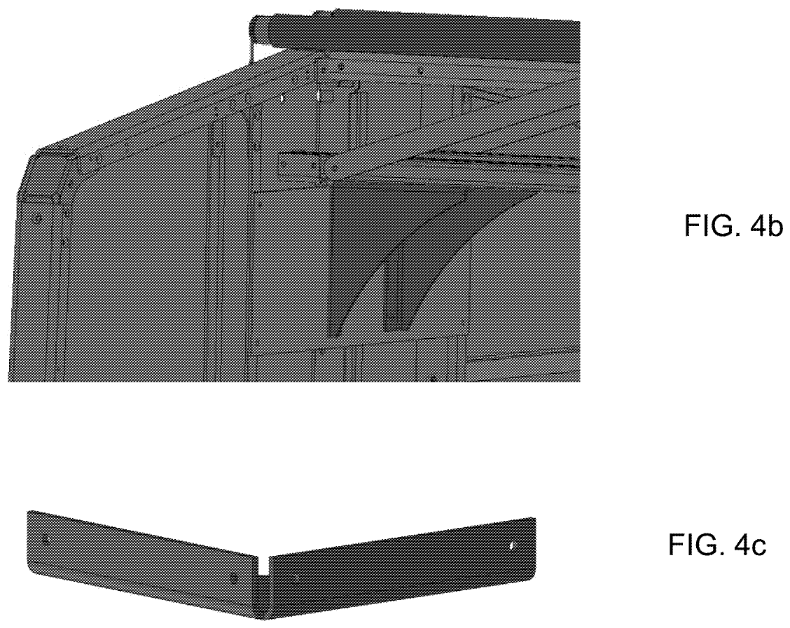

Referring now to FIGS. 3, 4a, 4b, and 4c, additional details of the support system 10 and its connection to the rear bulkhead wall 18 are shown. As shown, each truss 34 has an upper connection point 35 to the next truss 34 and the upper beam 30 and a lower connection point 37 to next truss 34 on its other side and its respective lower beam 32. A support plate 52 is attached to the rear bulkhead wall 18 to provide an attachment location for a pair of corner braces 36, which bears up and against the lower beams 32 to transfer forces to the rear bulkhead wall 18 as shown in FIG. 11. It can be appreciated that the same mechanism and structure can be utilized at the front bulkhead wall 16. It can also be appreciated that fewer or more than two corner braces 36 can be used. The pair is shown in greater detail in FIG. 4b and FIG. 4c illustrates a single brace 36 in isolation.

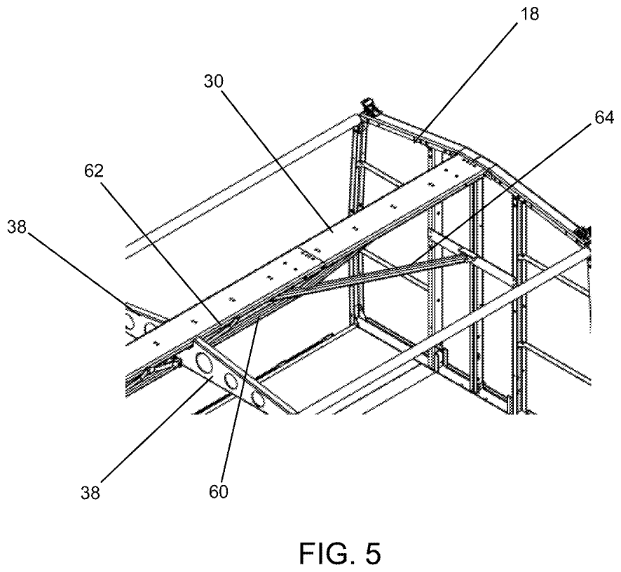

As indicated above, the particular arrangement of trusses 34 and the corner brace 36 shown in FIGS. 1-4 provide one configuration and others may be used at the potential expense of intrusion into the interior space of the trailer 12. For example, FIG. 5 illustrates another example configuration in which an alternative truss pattern 62 and lower beam 60 are used that bear against a relatively larger corner brace 64. It can be appreciated that the size and type of corner brace 36, 64 may be varied to suit trailers 12 of different lengths, tarpaulin systems of varying mass, etc. The type of corner brace 36, 64 may also be adapted to the load being hauled. For example, the corner brace 64 shown in FIG. 5 may be suitable when a relatively lower profile load is being carried and intrusion into the corner space is not an issue whereas in other scenarios this space may be required to accommodate or maximize a load. That is, the support system 10 and its modular and extensible design can be adapted to numerous configurations and applications where needed, providing increased flexibility in delivery, installation and deployment.

The modular support system 10 provides several advantages. For example, when compared to use a single beam, the upper beams 30 can more readily enable the support system 10 to be adapted to different trailer lengths, e.g., by adding or removing an upper beam 30 and/or by providing multiple segment lengths to further increase the possibilities. The modular design also enables the support system 10 be assembled on site and facilitates shipping to a customer or installer. That is, as discussed further below, the support system 10 with or without the tarpaulin system, can be packaged as a kit of components that can be more readily adapted for a particular trailer length, packaged, delivered, and assembled on site.

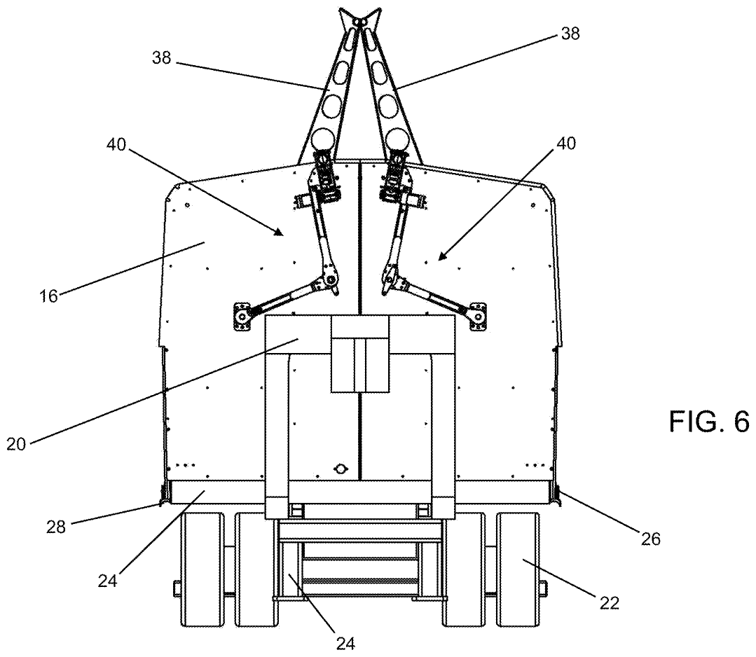

Referring now to FIG. 6, an end view of the trailer 12 shows that with a centrally installed support system 10 between pairs of rotatable arms 38, a large portion of the top and substantially the entirety of each side of the trailer 12 can be accessed for loading and unloading operations. The articulated actuation arms 40 being located outside of the interior of the trailer 12 and coupled to the front bulkhead wall 16 allow a tarpaulin system to be installed that can cover the entirety of the openings while being capable of minimal intrusion into such openings when in a retracted position wherein the tarpaulin is rolled up using a rod or spindle and secured atop the support system 10.

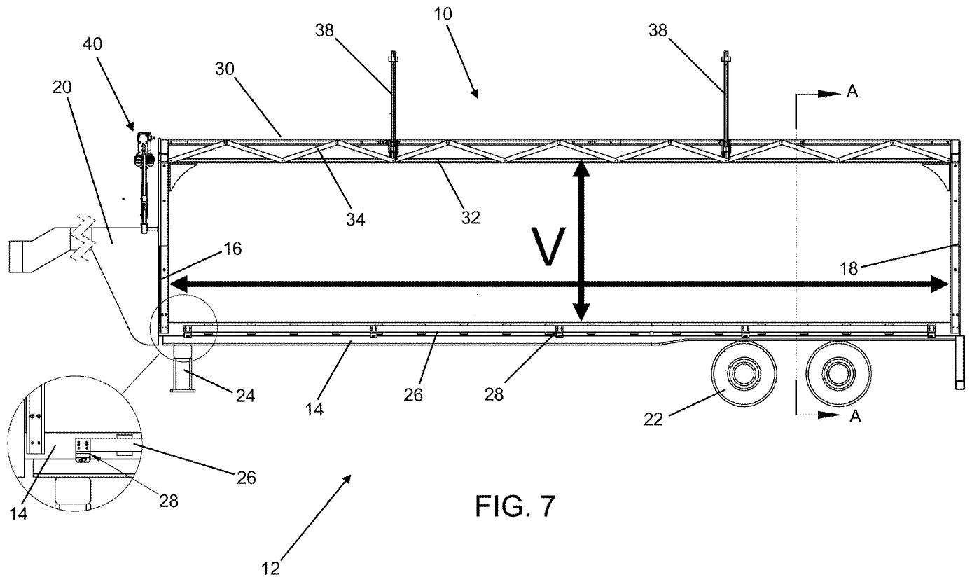

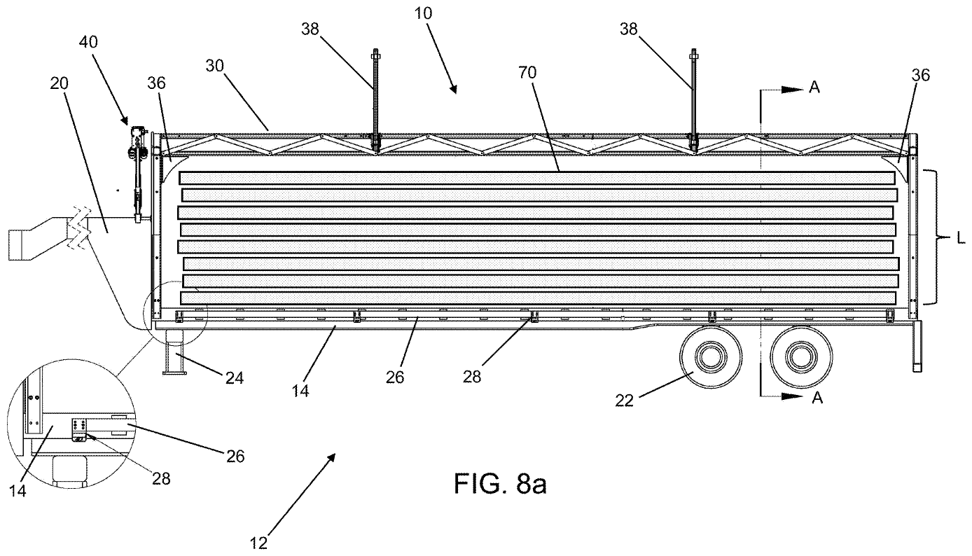

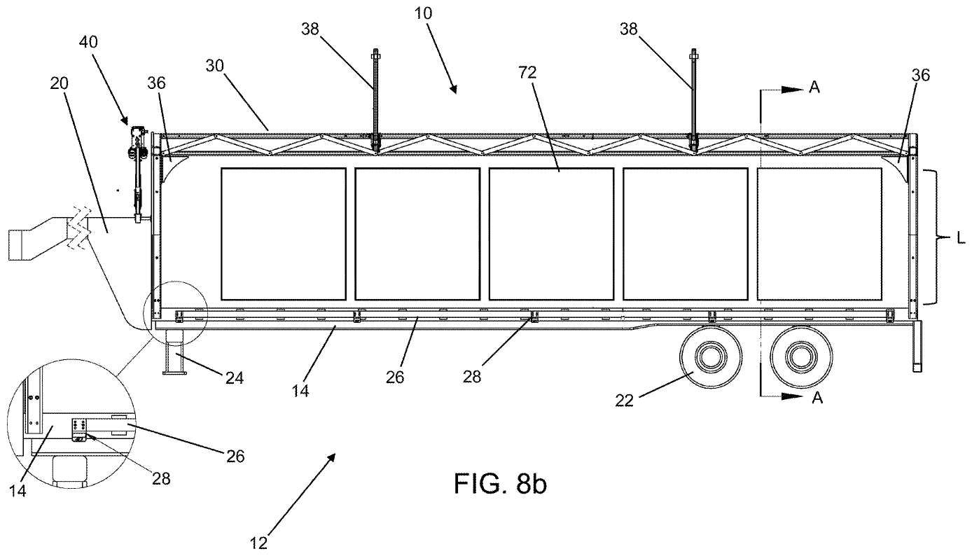

FIG. 7 illustrates a side view of the trailer configuration shown in FIG. 1, to further illustrate the increased volume (V) that is created by having a support system 10 and tarpaulin system that can be confined in the open position to a relatively slender (and possibly central or to one side) portion of the roof or top of the trailer 12. In this example it can be seen that the volume (V) may be defined substantially by height spanning between the lower beams 32 and the trailer bed 14, the length between the front and rear bulkhead walls 16, 18, and the width (not shown) across the bed 14 as would evident from the view in FIG. 1. Referring to FIG. 8a, this permits relatively longer items 70 such as steel, wood, rods and the like to be loaded from either side of the trailer 12 and across the entire width. A number of relatively bulkier items 72 such as boxed goods can more easily be accommodated when no central posts are intruding in the space as shown in FIG. 8b.

The volume (V) is further illustrated in FIG. 9 in which one of the bulkier items 72 can span under the support structure 10 since central posts do not obstruct loading. It can also be appreciated from this view that in the portion of the volume (V) that does not underly the support system 10, items 70, 72 being hauled may be taller or stacked higher than the lower beams 30 and up to the extents provided by the tarpaulin system. As such, the relatively slender support system 10 and the ability to omit central posts provides maximized ability to haul goods in various shapes and sizes. Moreover, the configuration show provides the ability to load vertically with a crane-type assembly.

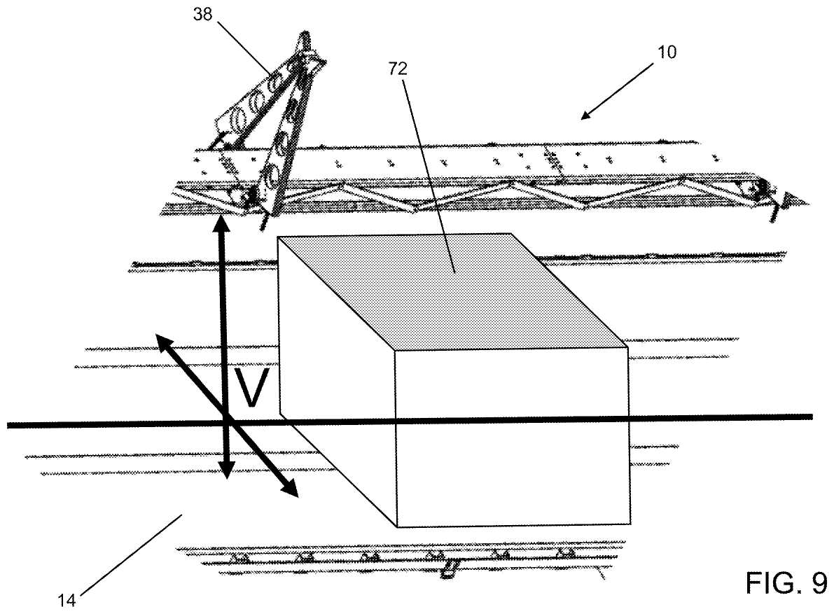

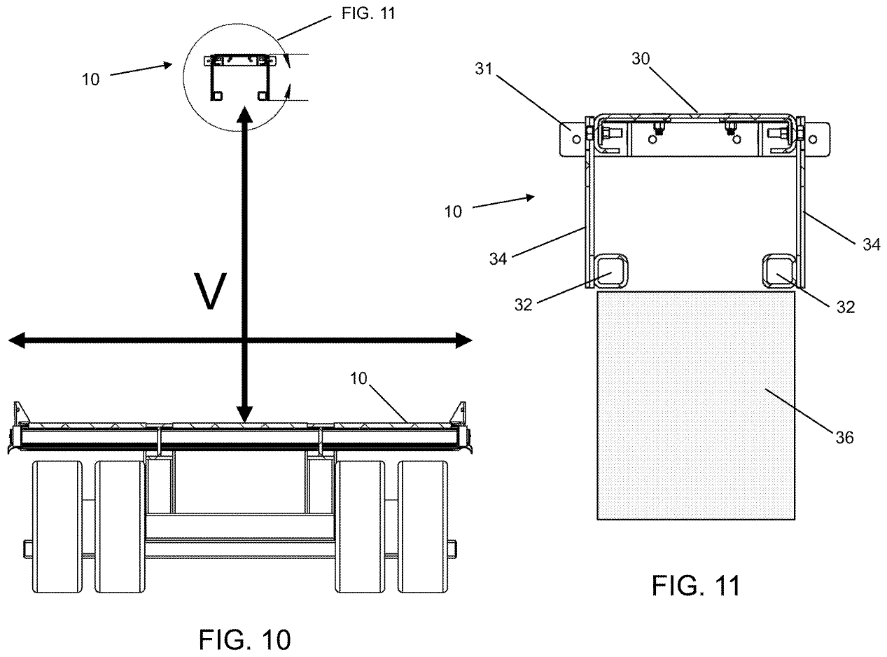

The cross-sectional end view of FIG. 10 further illustrates the minimal intrusion of the support system 10 into the overall cross section of the trailer 12. As indicated above, the cross-section of FIG. 11 further illustrates the assembled sets of trusses 34 along each side extending from the upper beam 30 to the respective lower beams 32. The assembly is therefore provided in sections, which lends itself to packaging, shipping, assembly, and extensibility/scalability for different sized trailers 12.

FIGS. 12 and 13 illustrate the trailer 12 with a tarpaulin system having a tarpaulin 100 attached to each side of the support system 10 and in a closed or extended configuration in which each tarpaulin 100 covers a portion of the top and a respective side of the trailer 12. The actuation arms 40 are shown coupled to each tarpaulin 100 via a rotating rod 102, which is rotated in one direction to unroll the tarpaulin 100 to cover the trailer opening and rotated in the opposite direction to roll up or otherwise retract the tarpaulin 100 to expose the trailer bed 14 and any goods being hauled by the trailer 12. The tarpaulin system may also include upper hooks 104 against which the rolled up tarpaulin 100 sits when the tarpaulin 100 is retracted. An enlarged view of such upper hooks 104 is shown in FIG. 14. From FIGS. 12-14 it can be appreciated that the support system 10 provides a rigid enough structure to maintain integrity of the roof created by the unrolled tarpaulin 100 while inhibiting collapse of the tarpaulin system if such a support system 10 were omitted. Moreover, the support system 10 provides stability in certain weather conditions such as in windy conditions and provides the rigidity needed to avoid the tarpaulin system from torquing towards either end of the trailer 12 when it is being operated.

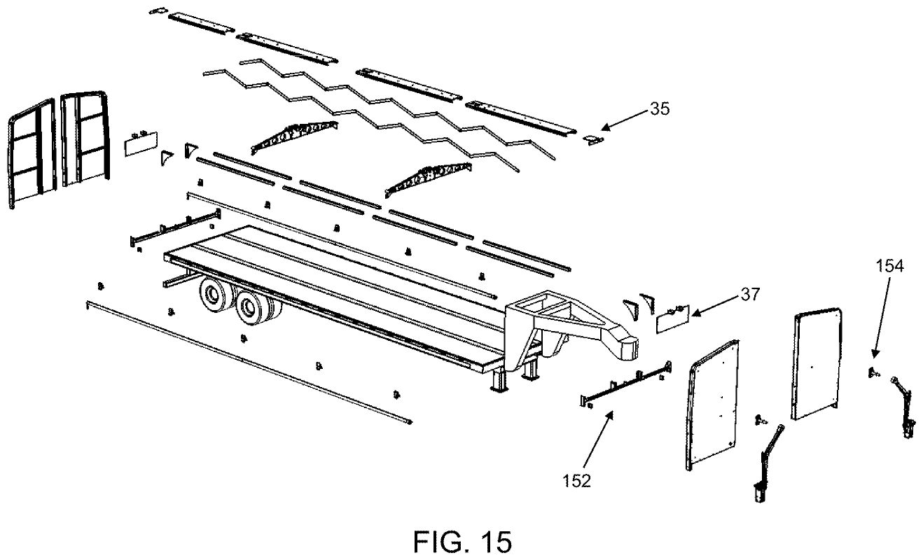

The support system 10 described herein provides a modular and extensible configuration to permit it to be adapted to various trailer types and sizes. Moreover, the modular design permits easier transport and assembly in, for example, a kit of parts. Referring now to FIG. 15, an exploded view of the system 10 is shown, with most reference numerals omitted for clarity of illustration. From this exploded view, certain additional components are shown. The upper beams 30 when assembled end to end as illustrated connect at each end to end brackets 35. The end brackets 35 are secured to the respective bulkhead 16, 18 via attachment plates 37. Also shown in FIG. 15 is a pair of pivot bases 154 for respective ones of the articulated arms 40. To connect the bulkheads 16, 18 to the trailer bed 14, a pair of bulkhead rails 152 are used and best seen in the exploded view of FIG. 15. The other components shown in the exploded view correspond to those features discussed above.

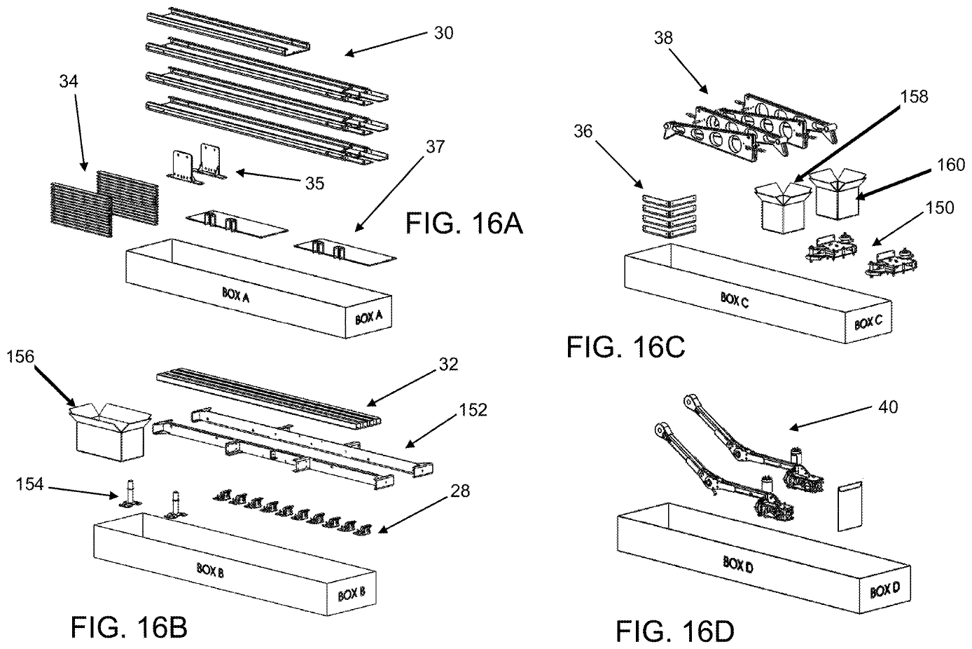

Referring now to FIGS. 16A-16D, the kit of parts illustrated by the exploded view of FIG. 15 enable compact packaging and shipping of the components. In this example, relatively long and slender boxes A, B, C, and D are used to each contain a number of the components.

Box A (FIG. 16A) in this example can package the trusses 34 when folded up over each other via the connections 35 therebetween, the upper beams 30 disconnected and stacked upon each other, the end brackets 35, and the attachment plates 37.

Box B (FIG. 16B) in this example can package the lower beams 32 stacked side by side, the bulkhead rails 152, the pivot bases 154, the hooks 28, and a hardware box 156.

Box C (FIG. 16C) in this example can package the corner braces 36, the support arms 38, and brackets 150 for the support arms 38, along with a control box 158 and a wiring box 160.

Box D (FIG. 16D) in this example can package the articulated arms 40 and, as shown, documentation or other paperwork.

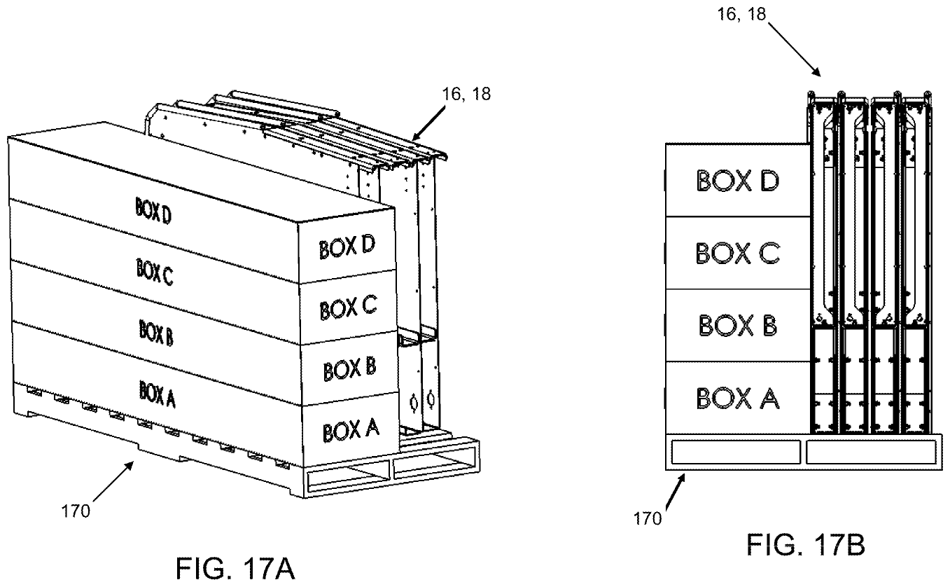

FIGS. 17A and 17B illustrate the boxes in a shipping package. In this example, Boxes A-D are stacked upon a shipping pallet 170 along with a stack of the bulkheads 16, 18 (in this example each in two pieces). It can be appreciated from FIG. 17 that the compact and modular design permits a kit of parts to be efficiently organized, packaged in a small number of boxes and supported on a shipping pallet 170 that is of a known configuration and can be lifted using a forklift or other similar moving equipment such as a pallet truck. When shipped to a site having the trailer bed 14, the components shown in their exploded view in FIG. 15 can be assembled according to a provided set of assembly instructions, which may vary depending on the size and number of components. The extensibility of the design further permits trailers 14 of different lengths to be accommodated by adjusting the number of parts provided in the kit providing a flexibly manufacturing, shipping and installation pipeline.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. A support system for supporting tarpaulin coverings for trailer beds, the system comprising:
a plurality of planar beams configured to be attached end to end to span an entire length of the trailer without an intermediate support post.

2. The support system of claim 1, further comprising:
a plurality of support elements configured to span the length of the trailer.

3. The support system of claim 2, wherein the plurality of support elements are configured to support the plurality of planar beams.

4. The support system of claim 1, further comprising:
a pair of brace components positioned between ends of the beams.

5. The support system of claim 1, further comprising:
support elements and upstanding walls of the trailer positioned at each end.

6. The support system of claim 1, further comprising:
a pair of brace components positioned between ends of the beams and support elements and upstanding walls of the trailer positioned at each end.

7. The support system of claim 2, wherein the plurality of support elements comprises a plurality of trusses.

8. The support system of claim 7, wherein the plurality of trusses are coupled together and to the beams.

9. The support system of claim 7, wherein the trusses span between the planar beams and a plurality of slender beams positioned beneath the plurality of planar beams.

10. The support system of claim 4, wherein the brace components comprise an arcuate face and a pair of corner faces.

11. The support system of claim 10, wherein an upper corner face is positioned against the plurality of support elements and a substantially orthogonal end face is positioned against a respective upstanding wall.

12. The support system of claim 1, further comprising at least one support member positioned along the support system.

13. The support system of claim 12, wherein each support member is biased into an upstanding position and is urged into a substantially planar position when the tarpaulin covering unrolls thereover.

14. A kit of parts for assembling a support system for supporting tarpaulin coverings for trailer beds, the kit of parts comprising a support system for supporting tarpaulin coverings for trailer beds, the system comprising:
a plurality of planar beams configured to be attached end to end to span an entire length of the trailer without an intermediate support post.

15. The kit of parts of claim 14, packaged in a plurality of boxes sized to fit atop a shipping skid.
